(19) United States
(12) Patent Application Publication
(10) Pub. No.: US 2023/0278175 A1
(43) Pub. Date: Sep. 7, 2023

(54) Tool Change Upgrade Device

(71) Applicant: Derrick Dornburgh, Emerson, IA (US)

(72) Inventor: Derrick Dornburgh, Emerson, IA (US)

(21) Appl. No.: 18/179,065

(22) Filed: Mar. 6, 2023

Related U.S. Application Data
(60) Provisional application No. 63/317,031, filed on Mar. 6, 2022.

(51) Int. Cl. B25B 21/00

(52) U.S. Cl. CPC B25B 21/007

(57) ABSTRACT

The present invention relates to a novel driver attachment device. The device is designed to enable users to interchange the attachments to accommodate different sizes of screws. Specifically, the driver attachment device comprises an adapter component that is received by a drill featuring a Phillip's head screwdriver working end. The working end receives the adapter component, which is compatible with zip bit (or hex head) screws. The adapter component is two-sided and can be flipped to receive different size zip bit screws. The adapter component can further be removed to allow the Phillip's head working end to be used with Phillip's head screws. Thus, the device allows a user to address multiple different size and style screws that are common with HVAC works.

### CROSS-REFERENCE TO RELATED APPLICATION

The present application claims priority to, and the benefit of, U.S. Provisional Application No. 63/317,031, which was filed on Mar. 6, 2022 and is incorporated herein by reference in its entirety.

### FIELD OF THE INVENTION

The present invention relates generally to the field of driver attachments for a drill. More specifically, the present invention relates to an improved driver attachment device that provides users with an attachment component for a drill capable of receiving a Phillip's head screwdriver to apply different screw types. Accordingly, the present disclosure makes specific reference thereto. Nonetheless, it is to be appreciated that aspects of the present invention are also equally applicable to other like applications, devices and methods of manufacture.

### BACKGROUND

By way of background, the variety of screwdriver bit sizes and types which are required for most purposes makes it practical and economical to utilize a drill having interchangeable driver attachments. Further, multiple drivers may be required for a drill, forcing users to attach the different drivers to apply screws and other fasteners. Additionally, different size and style screws may be common with HVAC works and other items, and constantly swapping out drivers can be frustrating for users. Drivers can get lost and may not even fit in the impact drill.

Additionally, as a result of considerable developments within the field of power tools and the increased demand of the DIY market, the number of different types of power tools available to the consumer has risen considerably in the past decade. Whilst this considerable array of power tools is often found to be useful, owning such a large number is both expensive and requires a considerable amount of storage space. Accordingly, a need exists for an inexpensive, versatile, and easily operated driver attachment for a drill.

Therefore, there exists a long-felt need in the art for a driver attachment device that provides users with an attachment device for a drill capable of receiving a Phillip's head screwdriver to apply different screws. There is also a long-felt need in the art for a driver attachment device that enables users to interchange the attachments to accommodate different sizes of screws. Further, there is a long-felt need in the art for a driver attachment device that eliminates the worry of being unable to apply different screws and having to locate different bits for the drill. Moreover, there is a long-felt need in the art for a device that improves efficiency and workflow when working with different types of fasteners as an HVAC technician or other contractor. Further, there is a long-felt need in the art for a driver attachment device that is two-sided and can be flipped to receive different size zip bit (or hex head) screws. Finally, there is a long-felt need in the art for a driver attachment device that allows a user to address multiple different size and style screws that are common with HVAC works.

The subject matter disclosed and claimed herein, in one embodiment thereof, comprises a driver attachment device. The device is designed to enable users to interchange the attachments to accommodate different sizes of screws. Specifically, the driver attachment device comprises an adapter component that is received by a drill featuring a Phillip's head screwdriver working end. The working end receives the adapter component, which is compatible with zip bit (or hex head) screws. The adapter component is two-sided and can be flipped to receive different size zip bit screws. The adapter component can further be removed to allow the Phillip's head working end to be used with Phillip's head screws. Thus, the device allows a user to address multiple different size and style screws that are common with HVAC works.

In this manner, the driver attachment device of the present invention accomplishes all of the foregoing objectives and provides users with a device that enables users to interchange the attachments to accommodate different sizes of screws. The device is configured to be used with a drill capable of receiving a Phillip's head screwdriver. The device improves efficiency and workflow when working with different types of fasteners as an HVAC technician or other contractor.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a driver attachment device. The device is designed to enable users to interchange the attachments to accommodate different sizes of screws. Specifically, the driver attachment device comprises an adapter component that is received by a drill featuring a Phillip's head screwdriver working end. The working end receives the adapter component which is compatible with zip bit (or hex head) screws. The adapter component is two-sided and can be flipped or rotated to receive different size zip bit screws. The adapter component can further be removed to allow the Phillip's head working end to be used with Phillip's head screws. Thus, the device allows a user to address multiple different size and style screws that are common with HVAC works.

In one embodiment, the driver attachment device is configured to be used with a drill, or any other suitable power tool, as is known in the art. The drill comprises a drill chuck component for accepting conventional drill bits or drivers, such as a Phillip's head driver, etc. Typically, the drill accepts a removable Phillip's head driver for use with the driver attachment device. Thus, once attached, the drill comprises a Phillip's head screwdriver working end. The working end can be utilized as any typical working end, to contact and engage Phillip's head screws. Accordingly, the working end is used for driving a Phillip's head screw.

In one embodiment, the adapter component of the device comprises a generally cylindrical configuration with a receptacle, however the adapter component can be any suitable shape as is known in the art. In this embodiment, each end of the cylindrical configuration would comprise an opening sized to accept a specific zip bit (or hex head) screw. The opposing ends would each comprise an opening of different size, such that the opposing ends would accept different sized screws. For example, a first end of the cylindrical configuration would accept hex head screws of ¼^{th} inch hex and a second end of the cylindrical configuration would accept hex head screws of 5/16^{th} inch hex. Any suitable hex of the hex head screws can be utilized depending on the needs and/or wants of a user. Typically, HVAC ducts and their parts are assembled with hex head screws and bolts, many of which are self-drilling or self-piercing ZIP screws.

In one embodiment, the receptacle of the adapter component comprises an internal Phillip's head adaptor component which contacts and engages with the Phillip's head screwdriver working end of the drill. Further, the Phillip's head screwdriver working end also comprises a collet, positioned after the tip of the Phillip's head driver. The collet acts as a stop, such that once the adapter component is inserted onto the screwdriver working end, the adapter component is slid onto the working end until it contacts the collet. Once contact is made, the adapter component can be utilized. After use, if the user desires a different sized screw diameter, the adapter component can be flipped or rotated around and then reinserted onto the working end of the drill, with the desired screw size exposed for use.

In one embodiment, once the adapter component is inserted onto the working end of the drill, set screws are used to secure the adapter component to the drill. In another embodiment, the adapter component comprises threads on an inner diameter which act to secure the adapter component to the drill (i.e., through corresponding or mating threads on the drill). Thus, the adapter component is rotated on the drill until suitable positioning of the adapter component is achieved for the specific application.

In one embodiment, the driver attachment device can be packaged as a kit. The kit would include a plurality of adapter components with openings to accept different sizes of screws. Any number of adapter components can be packaged with the kit depending on the needs and/or wants of a user. The kit would further comprise different sizes of Phillip's head drivers to be inserted onto a drill to create a Phillip's head screwdriver working end. Once the Phillip's head drivers are secured to the drill, a user can choose the adapter component with the desired screw sizes and secure it to the working end for use.

In another embodiment, the driver attachment device comprises a plurality of indicia on the adapter component.

In yet another embodiment, the driver attachment device is manufactured from a lightweight material, such as aluminum or titanium alloys, stainless steel, cobalt chrome, etc., or any other suitable materials as is known in the art.

In yet another embodiment, the driver attachment device is manufactured from a material that is water resistant or water permeable or comprises a coating that is water resistant or water permeable.

In yet another embodiment, a method of providing users with a driver attachment device for a drill to apply different screws is described. The method includes the steps of inserting the adapter component with the desired screw size, from the driver attachment device, onto the working end of the drill. The method also comprises rotating the adapter component and securing the opposite end of the adapter component to the working end of the drill, such that the adapter component receives different sized screws. Further, the method comprises removing the adapter component from the working end. Finally, allowing Phillip's head screws to be used with the working end.

In yet another embodiment of the present invention, a driver attachment device is disclosed for allowing users to interchange drill attachments to accommodate different sizes of screws. Specifically, the driver attachment device comprises an adapter component that is received by a drill featuring a Phillip's head screwdriver working end. The working end receives the adapter component, which is compatible with zip bit (or hex head) screws. The adapter component is two-sided and can be flipped or rotated to receive different size hex head screws. The adapter component can further be removed to allow the Phillip's head working end to be used with Phillip's head screws. Thus, the device allows a user to address multiple different size and style screws that are common with HVAC technicians and other contractors.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the driver attachment device of the present invention, disclosing the adapter component secured to the working end of a Phillip's head screwdriver in accordance with the disclosed architecture;

FIG. 2 illustrates a perspective view of how the adapter components of one potential embodiment of the driver attachment device of the present invention can be interchanged with a drill in accordance with the disclosed architecture;

FIG. 3 illustrates a perspective view of how the screwdriver working end can accommodate a screw in accordance with the disclosed architecture;

FIG. 4 illustrates a perspective view disclosing the different sizes of adapter components for the driver attachment device of the present invention in accordance with the disclosed architecture;

FIG. 5 illustrates a perspective view of one potential embodiment of the driver attachment device of the present invention in use, in accordance with the disclosed architecture; and

FIG. 6 illustrates a flowchart showing one potential method of providing users with the driver attachment device of the present invention for a drill to easily and quickly apply different screws in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a driver attachment device that provides users with an attachment device for a drill capable of receiving a Phillip's head screwdriver to apply different screws. There is also a long-felt need in the art for a driver attachment device that enables users to interchange the attachments to accommodate different sizes of screws. Further, there is a long-felt need in the art for a driver attachment device that eliminates the worry of being unable to apply different screws and having to locate different bits for the drill. Moreover, there is a long-felt need in the art for a device that improves efficiency and workflow when working with different types of fasteners as an HVAC technician or other contractor. Further, there is a long-felt need in the art for a driver attachment device that is two-sided and can be flipped to receive different size zip bit (or hex head) screws. Finally, there is a long-felt need in the art for a driver attachment device that allows a user to address multiple different size and style screws that are common with HVAC works.

The present invention, in one exemplary embodiment, is a novel driver attachment device. The device comprises an adapter component that is received by a drill featuring a Phillip's head screwdriver working end. The working end receives the adapter component, which is compatible with zip bit (or hex head) screws. The adapter component is two-sided and can be flipped to receive different size zip bit screws. The adapter component can further be removed to allow the Phillip's head working end to be used with Phillip's head screws. The present invention also includes a novel method of providing users with a driver attachment device for a drill to apply different screws. The method includes the steps of inserting the adapter component with the desired screw size from the driver attachment device onto the working end of the drill. The method also comprises rotating the adapter component and securing the opposite end of the adapter component to the working end of the drill, such that the adapter component receives different sized screws. Further, the method comprises removing the adapter component from the working end. Finally, allowing Phillip's head screws to be used with the working end.

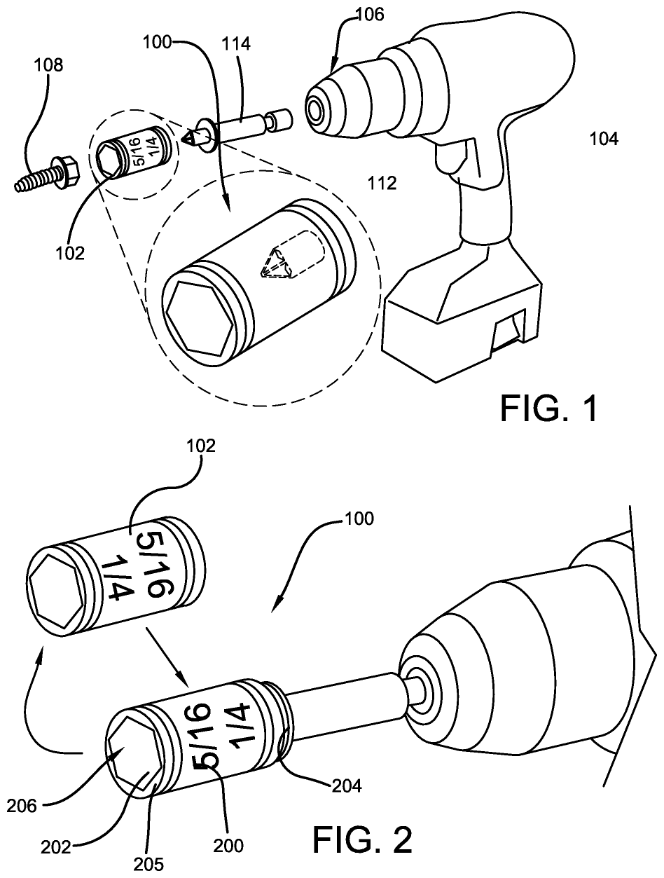

Referring initially to the drawings, FIG. 1 illustrates a perspective view of one embodiment of the driver attachment device 100 of the present invention. In the present embodiment, the driver attachment device 100 is an improved driver attachment device that allows a user to address multiple different size and style screws that are common with HVAC work. The device 100 is especially designed to allow HVAC technicians, or other contractors, etc., or any other suitable user as is known in the art, to interchange the attachments to accommodate different sizes of screws with one device.

The driver attachment device 100 comprises an adapter component 102, that is received by a drill 104 having a Phillip's head screwdriver working end 106. The working end 106 receives the adapter component 102, which is compatible with zip bit (or hex head) screws 108. The adapter component 102 is two-sided and can be flipped or rotated to receive different size hex head screws 108. The adapter component 102 can further be removed to allow the Phillip's head working end 106 to be used with Phillip's head screws 110. Thus, the device 100 allows a user to interchange adapter components 102 for different sizes and styles of screws 108, 110.

In one embodiment, the driver attachment device 100 is configured to be used with a drill 104, or any other suitable power tool, as is known in the art, depending on the needs and/or wants of a user. The drill 104 comprises a drill chuck component 112 for accepting conventional drill bits or drivers, such as a Phillip's head driver 114, etc. Typically, the drill 104 accepts a removable Phillip's head driver 114 for use with the driver attachment device 100. Thus, once attached, the drill 104 comprises a Phillip's head screwdriver working end 106. The working end 106 can be utilized as any typical working end, to contact and engage Phillip's head screws 110. Accordingly, the working end 106 is used for driving a Phillip's head screw 110.

FIG. 2 illustrates a perspective view of another embodiment of the driver attachment device 100 of the present invention. In this embodiment, the adapter component 102 of the device 100 comprises a generally cylindrical configuration 200 with an interior receptacle 202, however the adapter component 102 can be any suitable shape as is known in the art, depending on the needs and/or wants of a user. Furthermore, each end 204, 205 of the cylindrical configuration 200 would comprise an opening 206 sized to accept a specific zip bit (or hex head) screw 108, or any other suitable screws as is known in the art. The opposing ends 204, 205 would each comprise an opening 206 of a different size, such that the opposing ends 204, 205 would accept different sized screws 108. For example, a first end 204 of the cylindrical configuration 200 would accept hex head screws 108 of ¼^{th} inch hex and a second end 205 of the cylindrical configuration 200 would accept hex head screws 108 of 5/16^{th} inch hex. Any suitable hex of the hex head screws 108 can be utilized depending on the needs and/or wants of a user. Typically, HVAC ducts and their parts are assembled with hex head screws 108 and bolts, many of which are self-drilling or self-piercing ZIP screws.

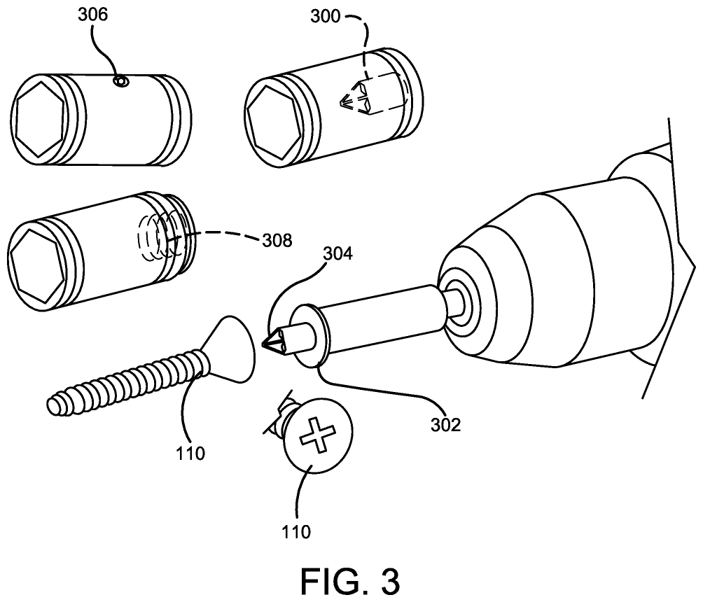

FIG. 3 illustrates a perspective view of another embodiment of the driver attachment device 100 of the present invention. In this embodiment, the receptacle 202 of the adapter component 102 comprises an internal Phillip's head adapter component 300 which contacts and engages with the Phillip's head screwdriver working end 106 of the drill 104. Further, the Phillip's head screwdriver working end 106 also comprises a collet 302 positioned after the tip 304 of the Phillip's head driver 114. The collet 302 acts as a stop, such that once the adapter component 102 is inserted onto the screwdriver working end 106, the adapter component 102 is slid onto the working end 106 until it contacts the collet 302. Once contact is made, the adapter component 102 can be utilized. After use, if the user desires a different sized screw hex, the adapter component 102 can be flipped or rotated around and then reinserted onto the working end 106 of the drill 104 with the desired screw size exposed for use.

In another embodiment, once the adapter component 102 is inserted onto the working end 106 of the drill 104, set screws 306 are used to secure the adapter component 102 to the drill 104. In another embodiment, the adapter component 102 comprises threads 308 on an inner diameter which act to secure the adapter component 102 to the drill 104 (i.e., through corresponding or mating threads on the drill 104). Thus, the adapter component 102 is rotated on the drill 104 until suitable positioning of the adapter component 102 is achieved for the specific application.

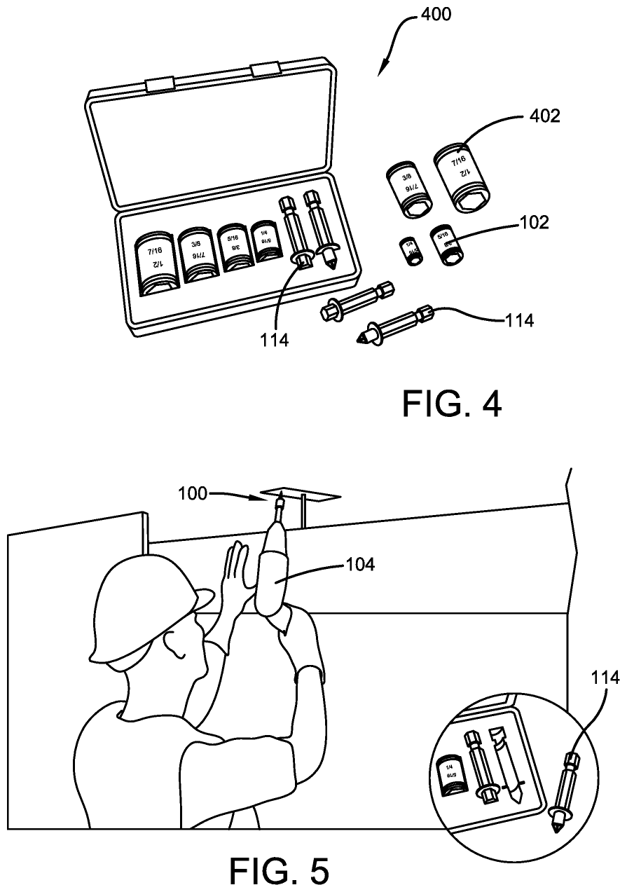

FIG. 4 illustrates a perspective view of another embodiment of the driver attachment device 100 of the present invention as a kit 400. In this embodiment, the driver attachment device 100 can be packaged as a kit 400. The kit 400 would include a plurality of adapter components 102 with openings 206 to accept different sizes of screws 108. Any number of adapter components 102 can be packaged with the kit 400 depending on the needs and/or wants of a user. The kit 400 would further comprise different sizes of Phillip's head drivers 114 to be inserted onto a drill 104 to create a Phillip's head screwdriver working end 106. Once the Phillip's head drivers 114 are secured to the drill 104, a user can choose the adapter component 102 with the desired screw sizes and secure it to the working end 106 for use.

In another embodiment, the driver attachment device 100 comprises a plurality of indicia 402 on the adapter component 102. Specifically, the adapter component 102 of the driver attachment device 100 may include advertising, a trademark, or other letters, designs, or characters, printed, painted, stamped, or integrated into the housing component, or any other indicia 402 as is known in the art. Specifically, any suitable indicia 402 as is known in the art can be included, such as, but not limited to, patterns, logos, emblems, images, symbols, designs, letters, words, characters, animals, advertisements, brands, etc., that may or may not be HVAC or brand related.

In yet another embodiment, the driver attachment device 100 is manufactured from a lightweight material, such as aluminum or titanium alloys, stainless steel, cobalt chrome, etc., or any other suitable materials as is known in the art. Further, the driver attachment device 100 is manufactured from a material that is water resistant or water permeable or comprises a coating that is water resistant or water permeable.

FIG. 5 illustrates a perspective view of another embodiment of the driver attachment device 100 of the present invention in use. In this embodiment, a driver attachment device 100 is disclosed for allowing users to interchange drill attachments to accommodate different sizes of screws 108, 110. Specifically, the driver attachment device 100 comprises an adapter component 102 that is received by a drill 104 featuring a Phillip's head screwdriver working end 106. The working end 106 receives the adapter component 102, which is compatible with zip bit (or hex head) screws 108. The adapter component 102 is two-sided and can be flipped or rotated to receive different size hex head screws 108. The adapter component 102 can further be removed to allow the Phillip's head working end 106 to be used with Phillip's head screws 110. Thus, the device 100 allows a user to address multiple different size and style screws 108, 110 that are common with HVAC technicians and other contractors.

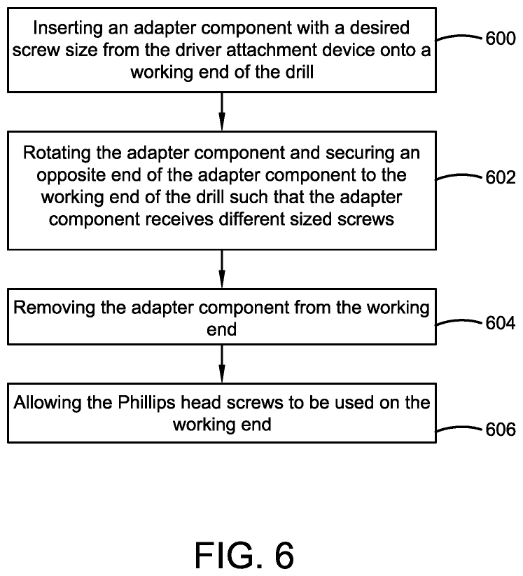

FIG. 6 illustrates a flowchart of the method of providing users with a driver attachment device for a drill to apply different screws. The method includes the steps of at 600, inserting the adapter component with the desired screw size from the driver attachment device onto the working end of the drill. The method also comprises at 602, rotating the adapter component and securing the opposite end of the adapter component to the working end of the drill, such that the adapter component receives different sized screws. Further, the method comprises at 604, removing the adapter component from the working end. Finally, at 606, allowing Phillip's head screws to be used with the working end.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “driver attachment device” and “device” are interchangeable and refer to the driver attachment device 100 of the present invention.

Notwithstanding the foregoing, the driver attachment device 100 of the present invention can be of any suitable size and configuration as is known in the art without affecting the overall concept of the invention, provided that it accomplishes the above-stated objectives. One of ordinary skill in the art will appreciate that the driver attachment device 100 as shown in FIGS. 1-6 is for illustrative purposes only, and that many other sizes and shapes of the driver attachment device 100 are well within the scope of the present disclosure. Although the dimensions of the driver attachment device 100 are important design parameters for user convenience, the driver attachment device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A driver attachment device that allows a user to easily and quickly interchange attachments to accommodate different sizes of screws with a drill, the driver attachment device comprising:
an adapter component;
wherein the adapter component is received by the drill;
wherein the drill comprises a Phillip's head screwdriver working end; and
further wherein the adapter component is sized and configured to be compatible with a hex head screw.

2. The driver attachment device of claim 1, wherein the drill comprises a drill chuck component for accepting a Phillip's head driver.

3. The driver attachment device of claim 2, wherein the drill accepts the Phillip's head driver, which forms the Phillip's head screwdriver working end.

4. The driver attachment device of claim 3, wherein the Phillip's head screwdriver working end is used for driving a Phillip's head screw.

5. The driver attachment device of claim 1, wherein the adapter component comprises a generally cylindrical configuration with an interior receptacle.

6. The driver attachment device of claim 5 further comprising an opening at each opposing end of the adapter component.

7. The driver attachment device of claim 6, wherein the opening is sized to accept a hex head screw.

8. The driver attachment device of claim 7, wherein the opening at a first end is sized to accept a hex head screw of ¼^{th} inch hex.

9. The driver attachment device of claim 8, wherein the opening at a second end is sized to accept a hex head screw of 5/16^{th} inch hex.

10. The driver attachment device of claim 9, wherein the interior receptacle of the adapter component comprises an internal Phillip's head adapter component.

11. The driver attachment device of claim 10, wherein the internal Phillip's head adapter component contacts and engages with the Phillip's head screwdriver working end of the drill.

12. The driver attachment device of claim 11, wherein the Phillip's head screwdriver working end comprises a collet.

13. The driver attachment device of claim 12, wherein the adapter component is inserted onto the Phillip's head screwdriver working end until it contacts the collet.

14. The driver attachment device of claim 1 further comprising a kit comprising a plurality of adapter components and a plurality of Phillip's head drivers.

15. A driver attachment device that allows a user to easily and quickly interchange attachments to accommodate different sizes of screws with a drill, the driver attachment device comprising:
an adapter component comprising an opening at each opposing end sized to accept a hex head screw;
wherein the adapter component is received by a drill;
wherein the drill comprises a drill chuck component for accepting a Phillip's head driver;
wherein the drill accepts the Phillip's head driver, which forms a Phillip's head screwdriver working end for driving a Phillip's head screw; and
wherein the adapter component comprises an internal Phillip's head adapter component which contacts and engages with the Phillip's head screwdriver working end of the drill.

16. The driver attachment device of claim 15 further comprising a plurality of indicia on the adapter component.

17. The driver attachment device of claim 15, wherein the Phillip's head screwdriver working end comprises a collet.

18. The driver attachment device of claim 17, wherein the adapter component is inserted onto the Phillip's head screwdriver working end until it contacts the collet.

19. The driver attachment device of claim 15 further comprising a kit comprising a plurality of adapter components and a plurality of Phillip's head drivers.

20. A method of providing users with a driver attachment device for a drill to apply different screws, the method comprising the steps of:
inserting an adapter component with a desired screw size, from the driver attachment device, onto a working end of the drill;
rotating the adapter component and securing an opposite end of the adapter component to the working end of the drill, such that the adapter component receives different sized screws;
removing the adapter component from the working end; and
allowing Phillip's head screws to be used with the working end.
